(19) United States
(12) Patent Application Publication
(10) Pub. No.: US 2015/0173999 A1
(43) Pub. Date: Jun. 25, 2015

(54) MASSAGE DEVICE

(71) Applicant: DRAKE & JOHNSON INNOVATION LTD, Valletta (MT)

(72) Inventor: John William Vanderstegen-Drake, Fulham London (GB)

(21) Appl. No.: 14/408,147

(22) PCT Filed: Jun. 17, 2013
(86) PCT No.: PCT/EP2013/062544

§ 371 Date: Dec. 15, 2014

(30) Foreign Application Priority Data
Jun. 15, 2012 (GB) 1210681.1

(51) Int. Cl. A61H 9/00; F04C 2/02

(52) U.S. Cl. CPC A61H 9/005; F04C 2/02; A61H 2201/0103; A61H 2201/1635

(57) ABSTRACT

A distributor for distributing a fluid has a motor, a base member and a rotor, which is driven by the motor and rotates against the base member. The base member has an infeed nozzle and a plurality of outfeed nozzles, while the rotor has a feed channel and a vent channel. The feed channel provides a fluid pathway between the infeed nozzle and one or more first nozzles of the outfeed nozzles and the vent channel provides a fluid pathway between one or more second nozzles of the outfeed nozzles and atmosphere.

The present invention relates to massage devices.

Massage is the working of superficial and deeper layers of muscle and connective tissue to enhance function, aid in the healing process, and promote relaxation and well-being. It is practised worldwide using many different techniques.

Massage devices are well-known. In particular, there are many massage chairs available on the market. These generally massage the spine but may also include means for massaging the arms or legs. In addition, hand and foot massagers are also known. Hand massagers may use an air bag to apply pressure to the hand and be designed to apply pressure to individual acupuncture pressure points on the hand. To that end, they may include beads on the outside of the air bag, in contact with the user's skin, to apply pressure to isolated points.

Large numbers of the adult population suffer from various forms of arthritis. On some estimates, about 1 in 5 of the adult population suffers from arthritis. Analgesia (painkillers) and anti-inflammatory drugs, including steroids, are used to suppress the symptoms of osteoarthritis, rheumatoid arthritis and other types of arthritis.

Rheumatoid arthritis is a debilitating form of the disease that affects parts of the body having flexible joints, in particular the hands. A typical symptom of rheumatoid arthritis is inflammation, with the affected joints being swollen, warm, painful and stiff, particularly early in the morning on waking or following prolonged inactivity. Increased stiffness early in the morning is often a prominent feature of the disease and typically lasts for more than an hour. Gentle movements may relieve symptoms, especially in early stages of the disease. However, it is difficult and painful for arthritis sufferers to make such gentle movements of their hands on waking or following prolonged inactivity, especially in more advanced stages of the disease. Moreover, existing hand massagers are not suited to the demands of arthritis sufferers and may be painful to use.

In addition, bed- and wheelchair-bound patients suffer problems due to unrelieved pressure on parts of the body resting in contact with the bed or wheelchair for long periods of time. They also suffer increased stiffness and muscle wastage through inactivity.

It is an object of the present invention to provide an effective massage device, which may be suited for use by sufferers of arthritis, wheelchair users and those remaining inactive for long periods of time.

According to a first aspect of the present invention, there is provided a distributor for distributing a fluid and comprising: a motor; a base member, and a rotor in driven relationship with the motor and rotatably engaging with the base member; the base member comprising an infeed nozzle and a plurality of outfeed nozzles, and the rotor comprising a feed channel and a vent channel, the feed channel being such as to provide a fluid pathway between the infeed nozzle and one or more first nozzles of the outfeed nozzles and the vent channel being such as to provide a fluid pathway between one or more second nozzles of the outfeed nozzles and atmosphere.

The distributor may comprise a resilient means for urging the rotor against the base member. This has the advantage of providing a better seal of the moving rotor against the fixed base member, with fewer consequent leaks.

The distributor may comprise a cap member disposed between the motor and the base member, the cap member accommodating at least part of the rotor and the resilient means.

The resilient means may be a compression spring, the distributor comprising a rotator plate disposed between the compression spring and the cap member, the distributor being such that the rotator plate can rotate with the rotor and the compression spring. The rotator plate may comprise one or more protrusions in contact with an inside surface of the cap member. Use of the rotator plate avoids the friction that would result from the spring turning against the cap member.

In accordance with a second aspect of the present invention, a fluid bag comprises: a first and second skin, the first skin defining a plurality of fluid-bag sections separated from each other by separating sections, the first and second skins being joined to each other at said separating sections and around a periphery of the first and second skins, each of said fluid-bag sections forming a cavity in a non-inflated state of the fluid bag; and a plurality of nozzles in fluid communication with respective fluid-bag sections.

The first and second skins are advantageously formed by a vacuum-forming process and joined by a welding process. Thermoplastic polyurethane may be employed for the skins.

In a third aspect of the present invention, a hand massager comprises pressure means for applying pressure to the fingers of a hand, the application of the pressure to the fingers travelling in a first direction from the fingertips towards the proximal ends of the fingers, or in the reverse direction.

The hand massager may comprise a fluid bag having a plurality of fluid-bag sections arranged adjacent to each other in the first direction, each for applying pressure sequentially to the fingers. Means may be provided for sequentially filling the plurality of fluid-bag sections with a fluid, whereby the fluid bag-sections sequentially apply pressure to the fingers. At the time of the application of pressure, each of the fluid bags may be partially filled with a predetermined volume of fluid, the massager further comprising displacement means adapted to displace the fluid within the respective bags sequentially, whereby the fluid bags in which fluid is displaced sequentially apply pressure to the fingers. The displacement means may comprise at least one solenoid.

The hand massager may further comprise a casing, wherein the fluid-bag sections are constrained by the casing when applying pressure to the fingers.

The hand massager may comprise a massage unit which is of a clamshell configuration having two portions joined by a hinge portion, and a fastening means for closing the clamshell, the massage unit including one or more of said fluid bags. A base unit may be provided, which includes a pump for pumping fluid to the sections of the one or more fluid bags. The massage unit may comprise a means for distributing said fluid to the fluid-bag sections.

The hand massager may further comprise a pressure sensor for sensing the pressure applied to the fingers. A heating means (e.g. an infrared heater, which may be of the carbon fibre type) may also be provided. A pressure release control may also be employed, which may be adapted to operate a suction device.

The distributing means of the hand massager may comprise the distributor as described above, wherein the outfeed nozzles of the distributor are connected to the fluid-bag sections. Also, the fluid bag may be as described above.

Embodiments of the present invention will now be described by way of further example only and with reference to the accompanying drawings, in which:

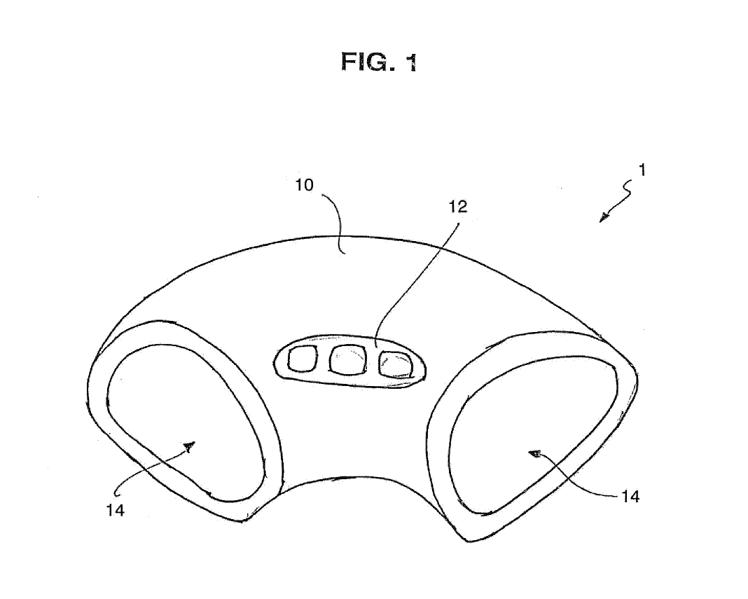

FIG. 1 is a schematic view of a hand massager according to the present invention;

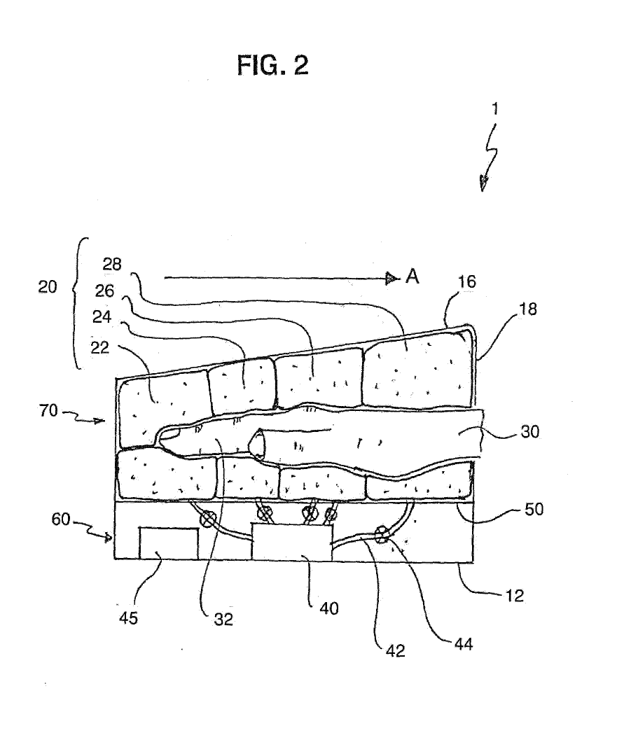

FIG. 2 is a schematic longitudinal cross-sectional view of the hand massager;

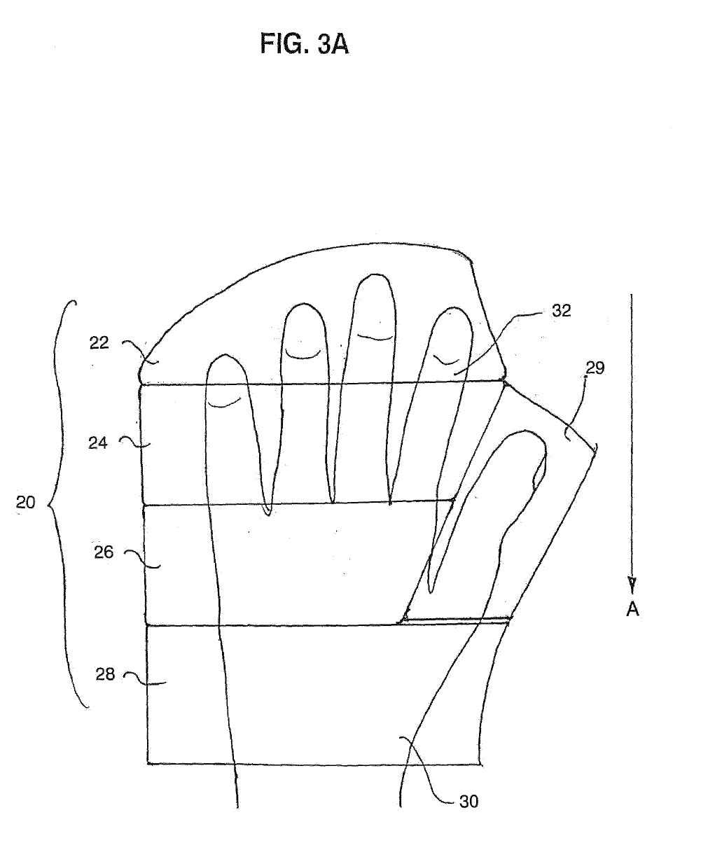

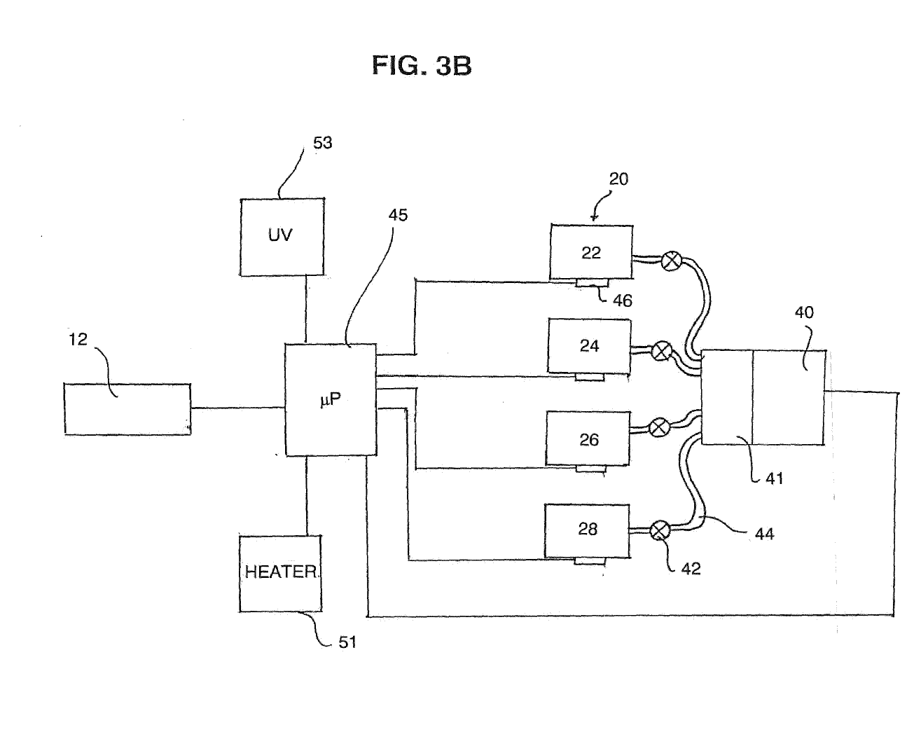

FIG. 3A is a schematic plan view of massage elements in relation to the hand and FIG. 3B is a schematic representation of the circuitry of the massager;

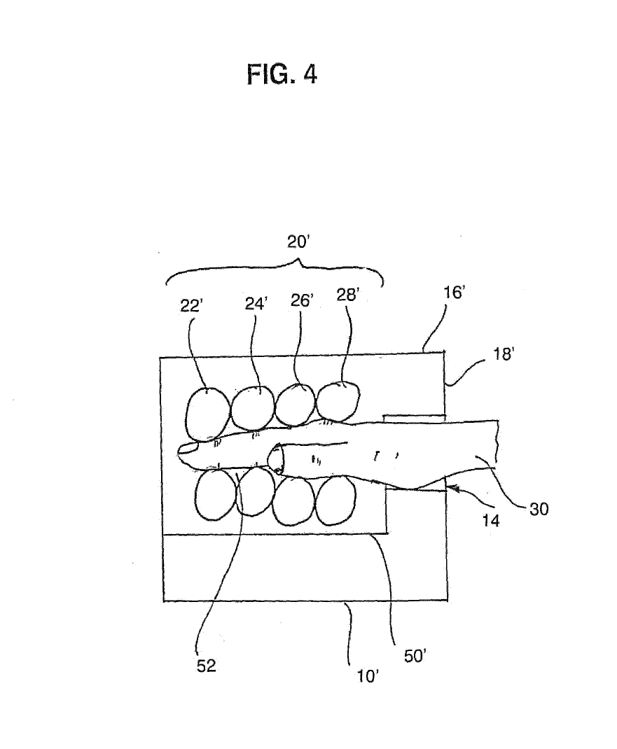

FIG. 4 is a schematic longitudinal cross-sectional view of a hand massager in another embodiment of the present invention;

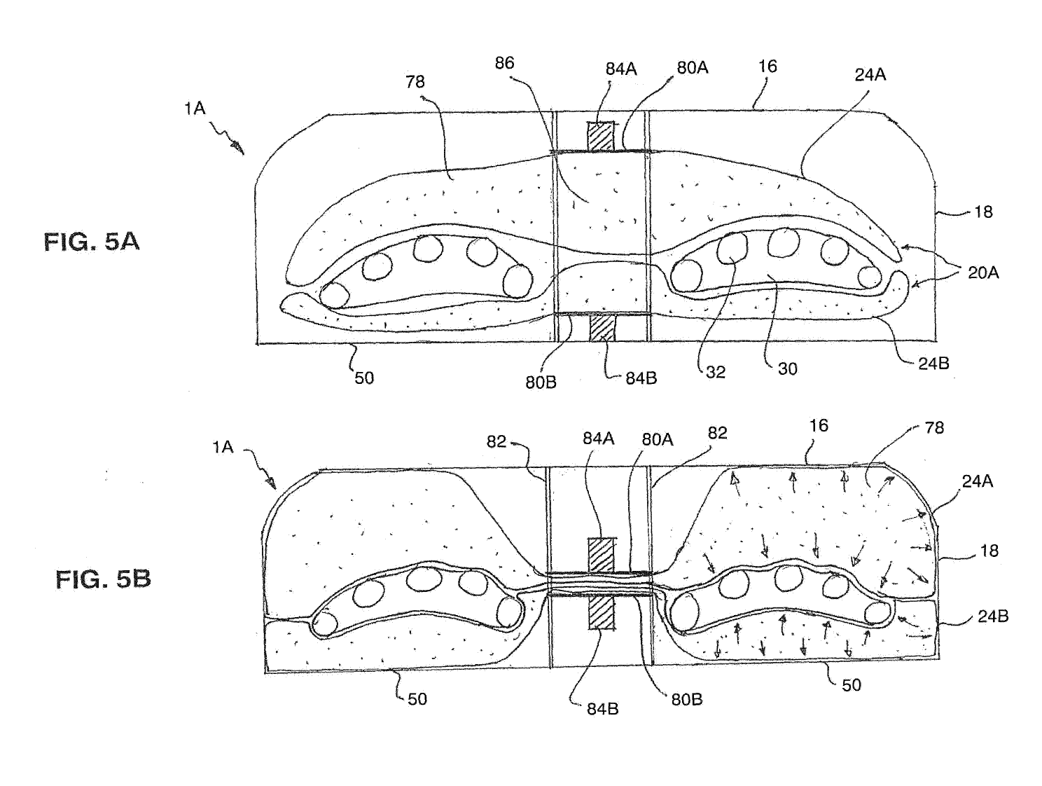

FIGS. 5A and 5B are schematic transverse cross-sectional views showing the operation of a hand massager in another embodiment of the present invention;

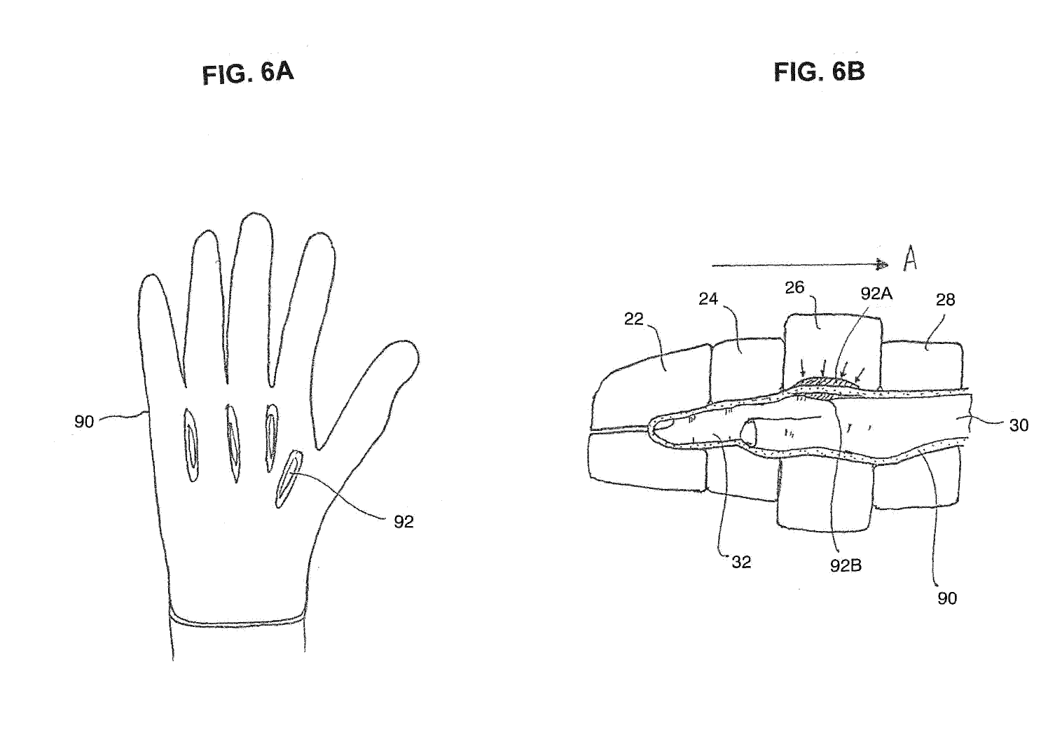

FIGS. 6A and 6B are a plan view and a longitudinal cross-sectional view of a hand massager in another embodiment of the present invention;

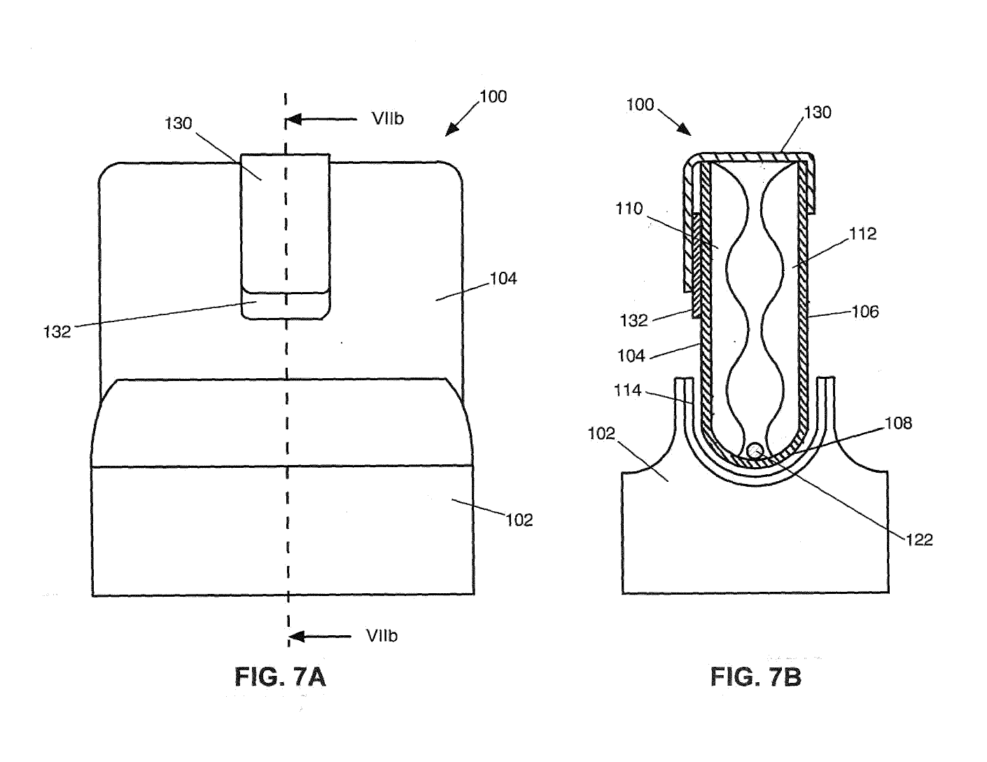

FIGS. 7A and 7B are front and cross-sectional side views, respectively, of a hand massager in another embodiment of the present invention;

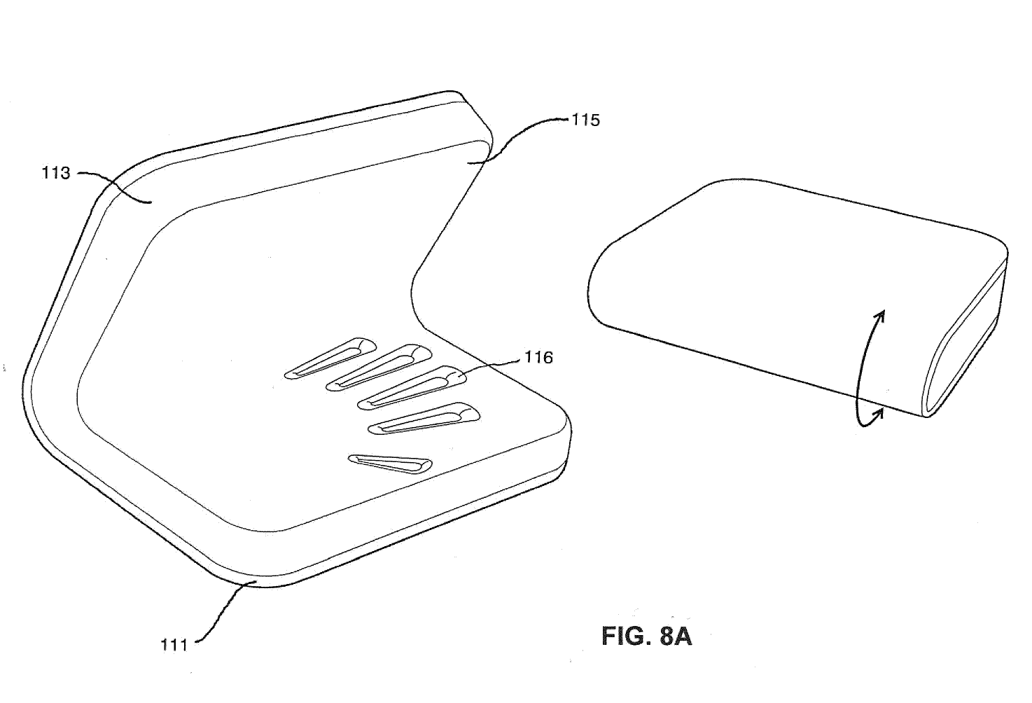

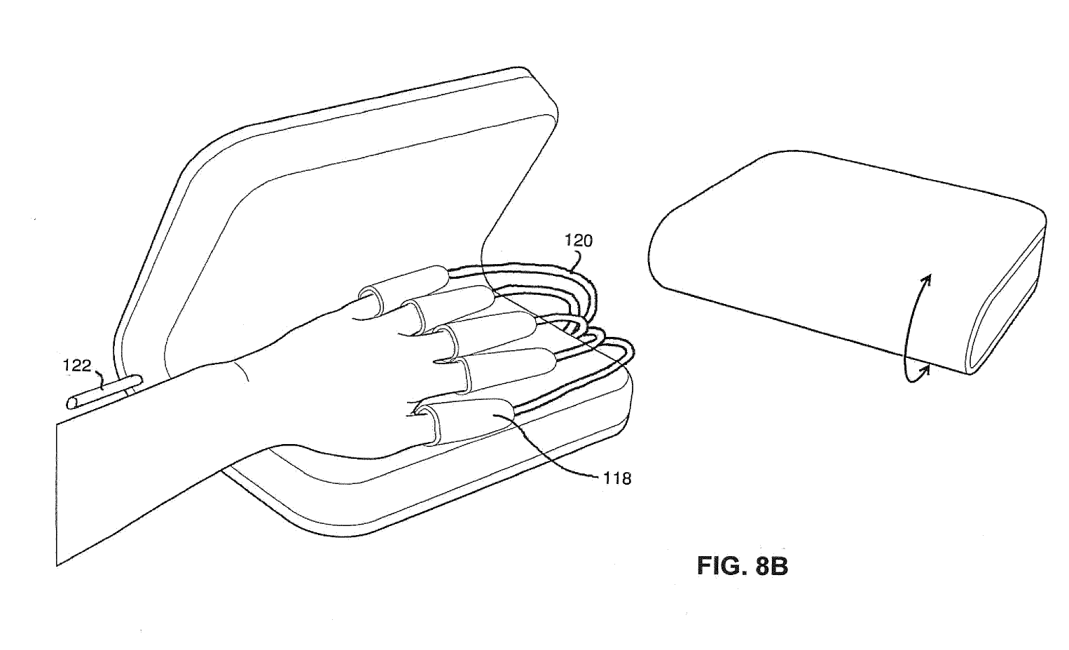

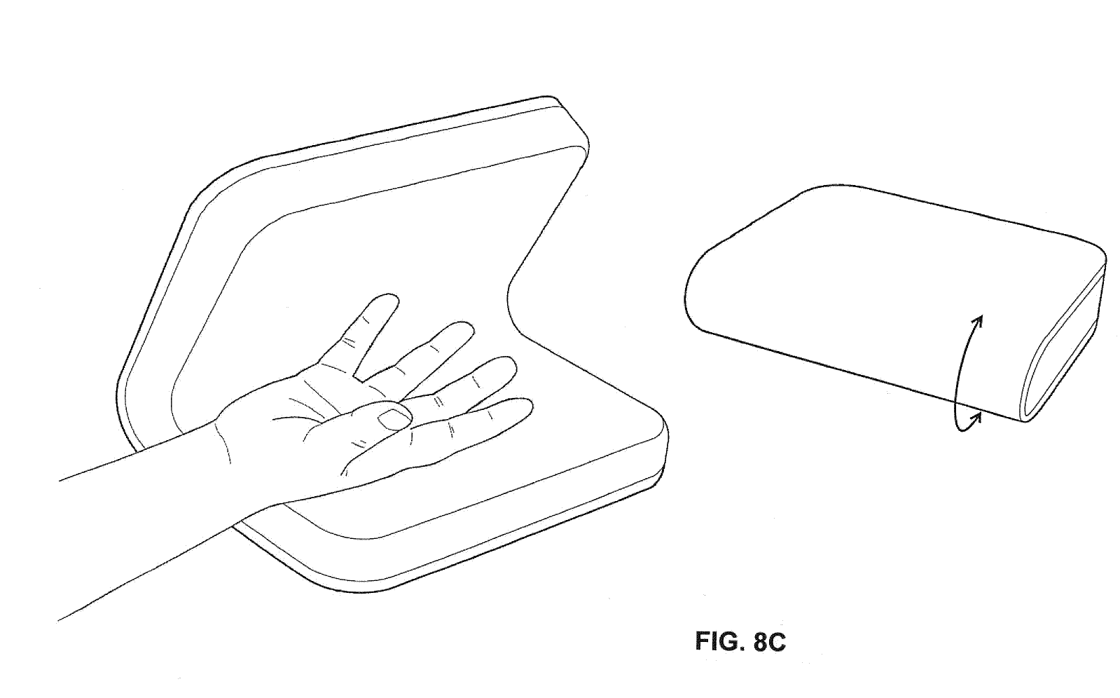

FIGS. 8A-8C are perspective views of a hand massage unit employed as part of the hand massager of FIGS. 7A and 7B; and

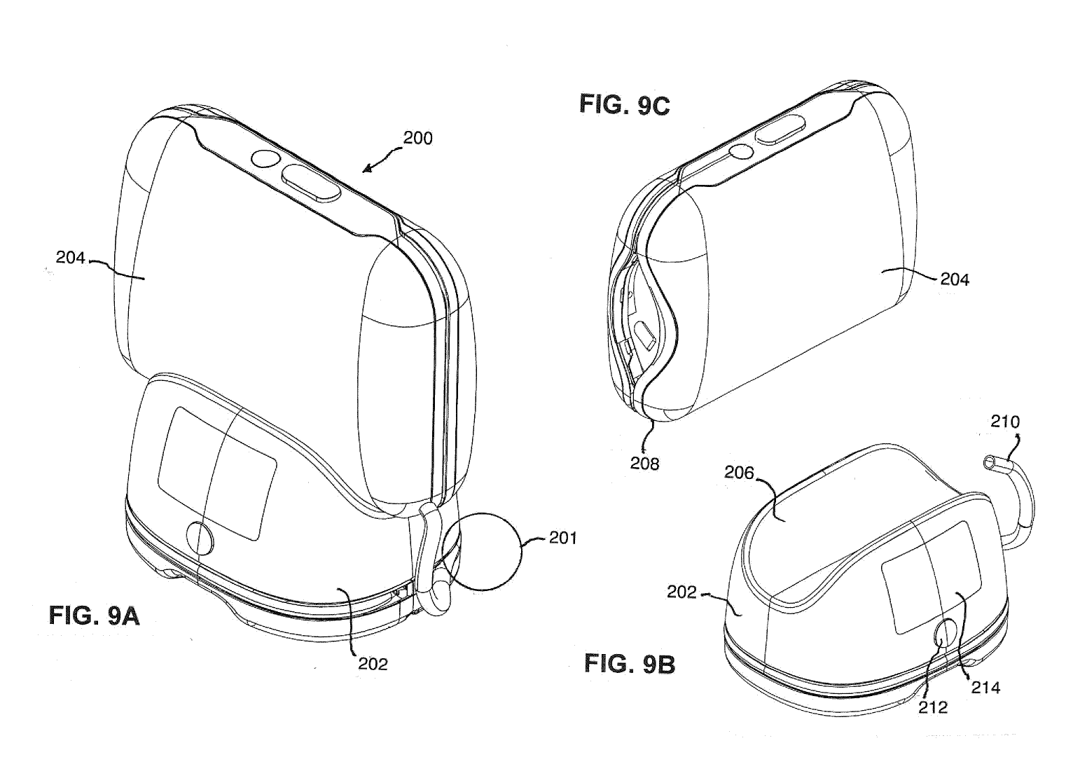

FIGS. 9A-9C are perspective views of a hand massager in another embodiment of the present invention;

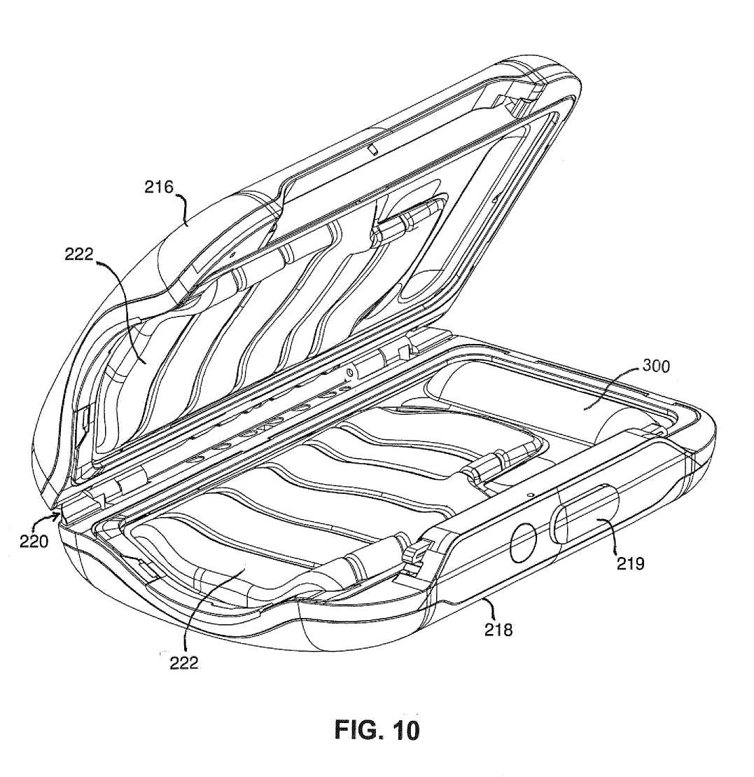

FIG. 10 is a perspective view of an opened-up hand-unit portion of the hand massager illustrated in FIGS. 9A-9C;

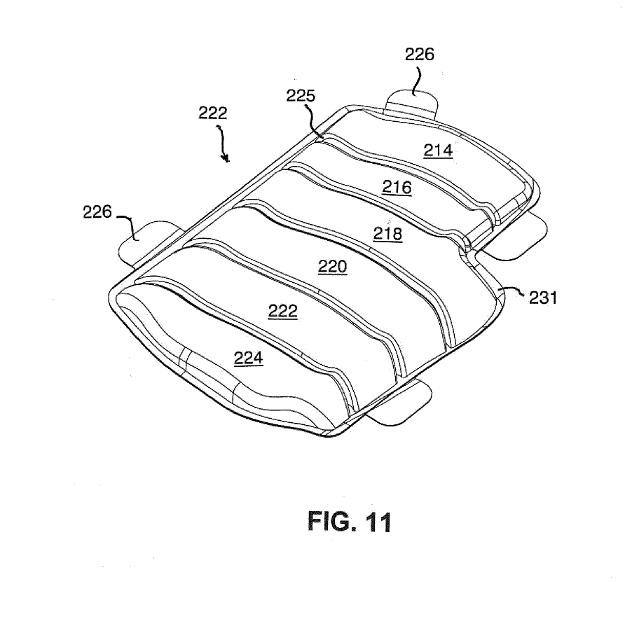

FIG. 11 is a perspective view of a fluid bag as employed in the hand unit portion of FIG. 10;

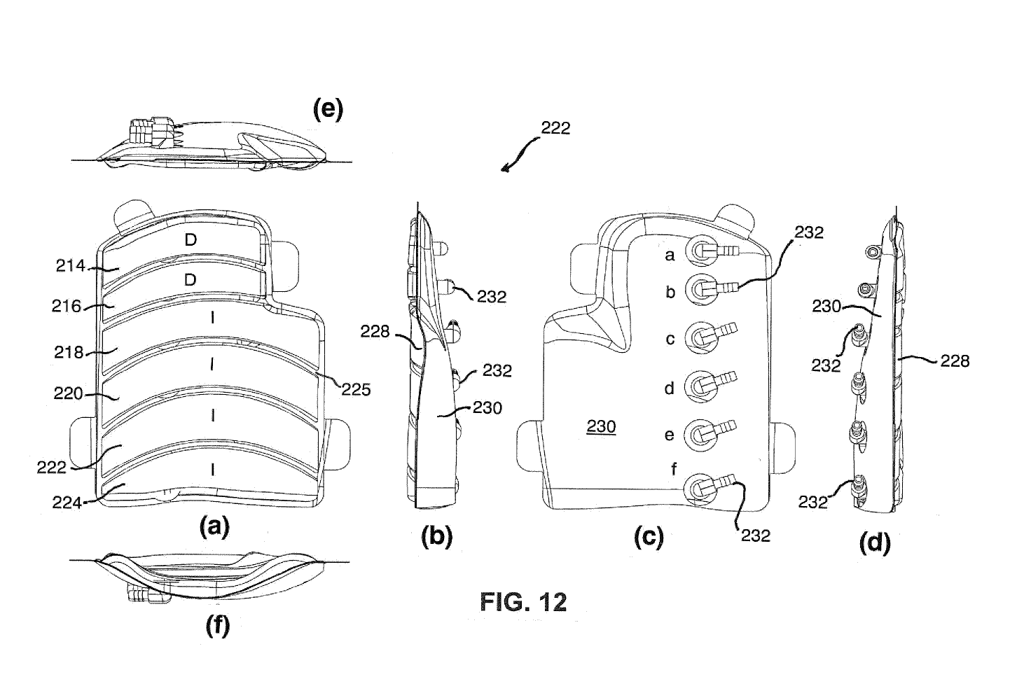

FIGS. 12(a)-(f) are orthographic views of the fluid bag of FIG. 11:

FIG. 13 is a plan view of the fluid bag of FIGS. 11 and 12 with hand superimposed;

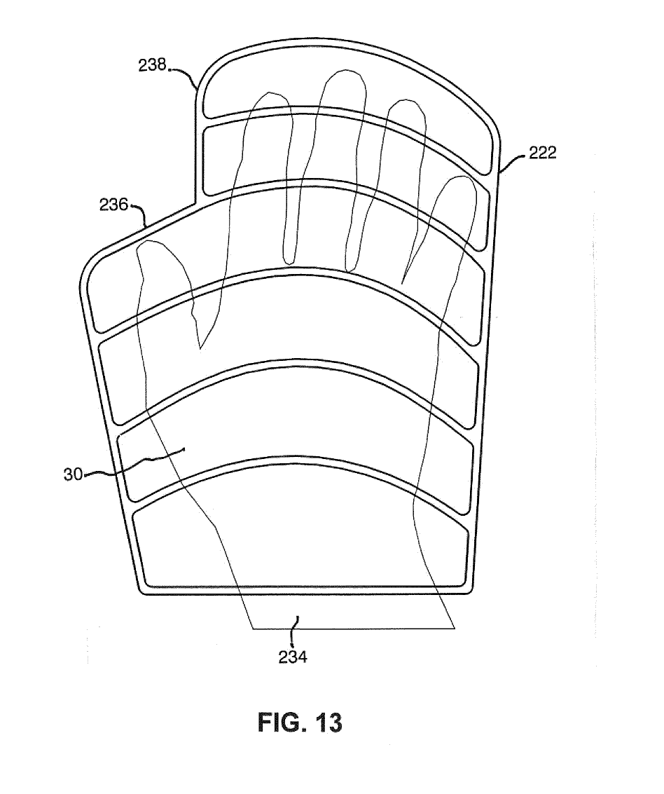

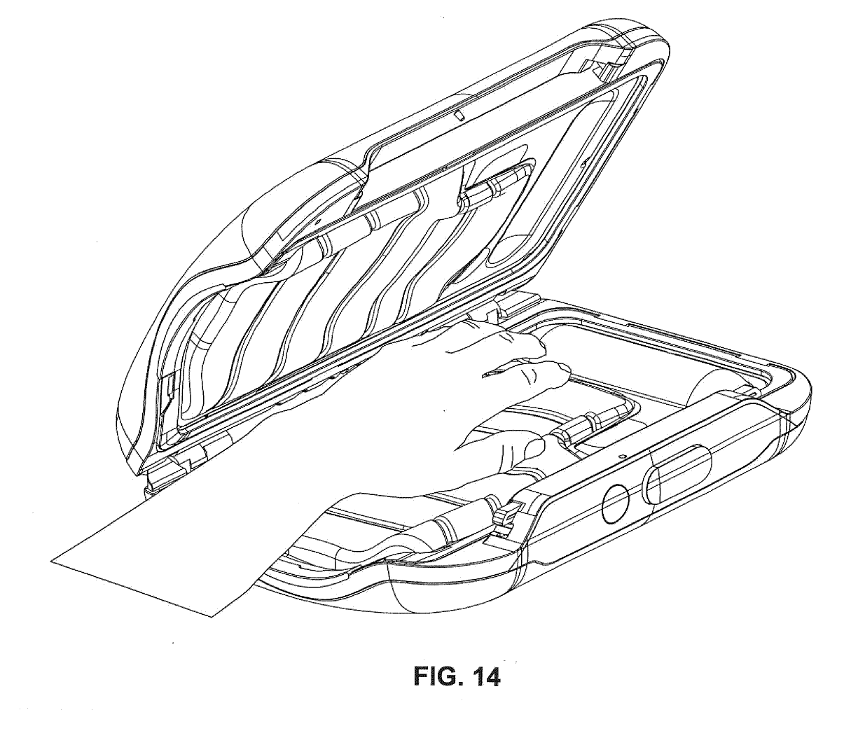

FIG. 14 is a perspective view of the opened-up hand-unit portion with hand inserted therein;

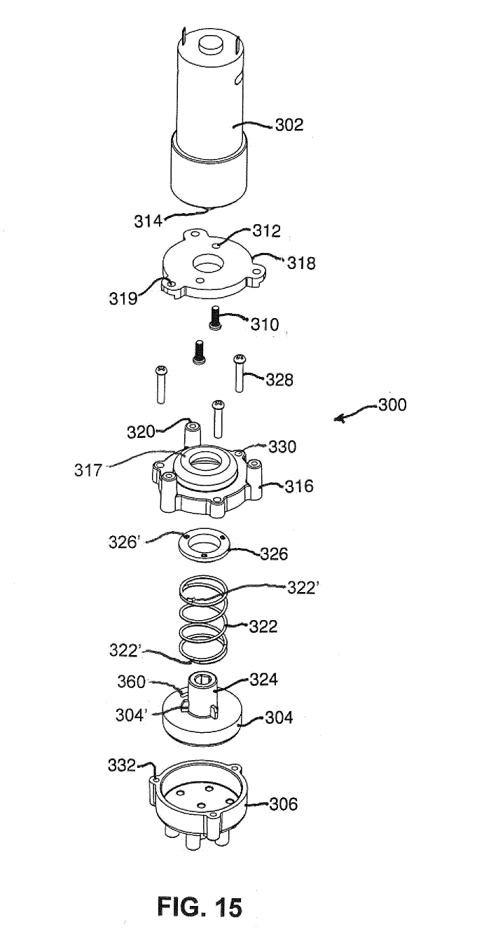

FIG. 15 is an exploded view of a fluid distributor as employed in the hand massager of FIGS. 9A-9C;

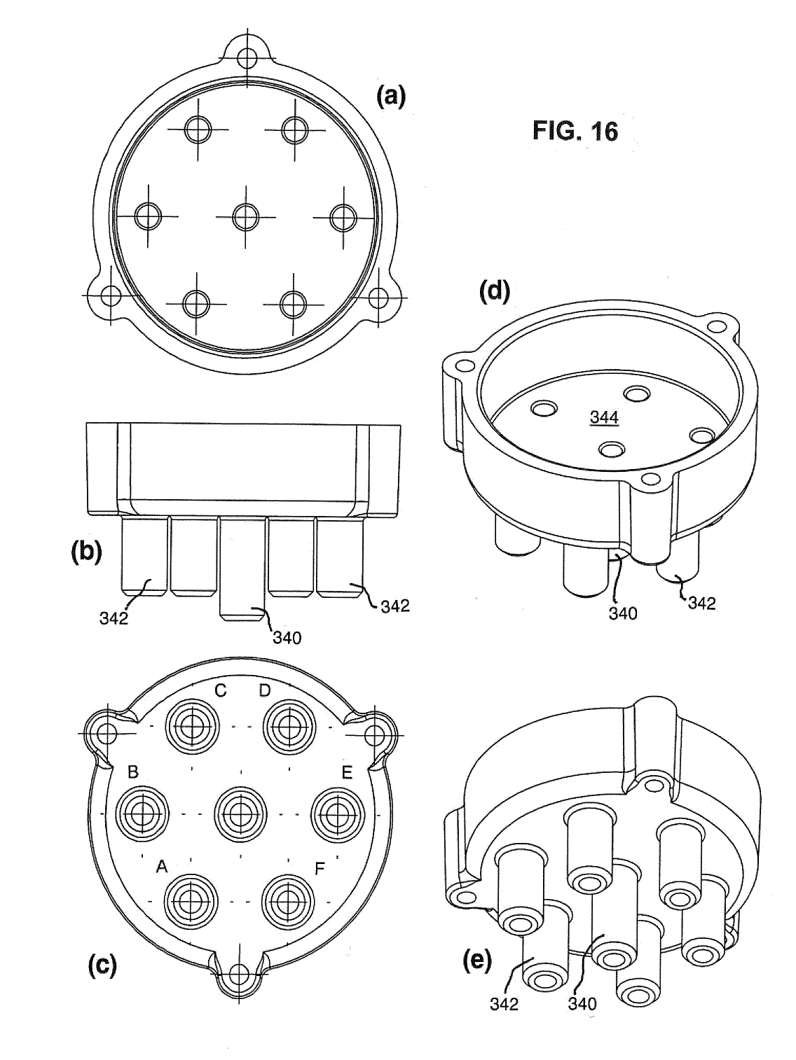

FIGS. 16(a)-(e) are orthographic and perspective views of a base member of the distributor of FIG. 15;

FIGS. 17(a)-(d) are orthographic and perspective views of a rotor portion of the distributor of FIG. 15;

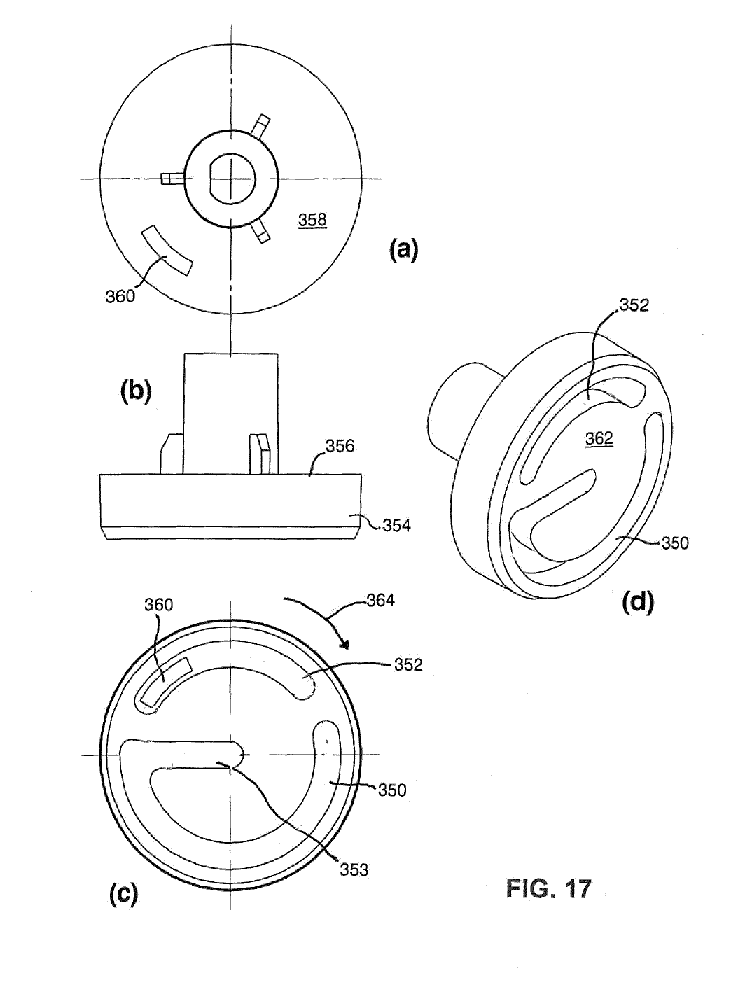

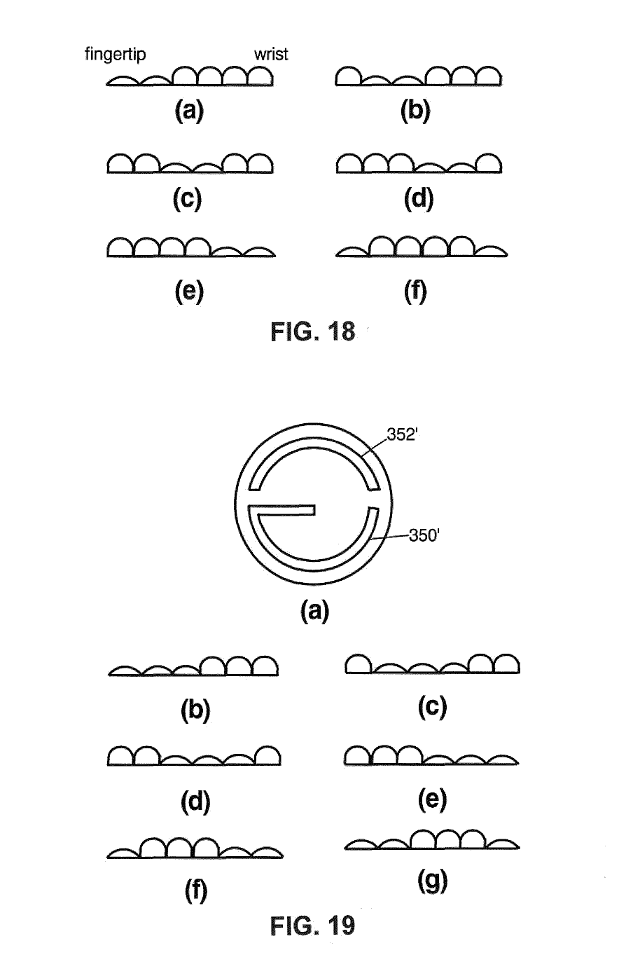

FIGS. 18(a)-(f) are simplified side views of a fluid bag showing a principle of one mode of operation of an embodiment of the hand massager of FIGS. 9A-9C;

FIG. 19(a) is a modified rotor configuration and FIGS. 19(b)-19(g) are simplified side views of a fluid bag showing a principle of another mode of operation of an embodiment of the hand massager of FIGS. 9A-9C resulting from the modified rotator configuration;

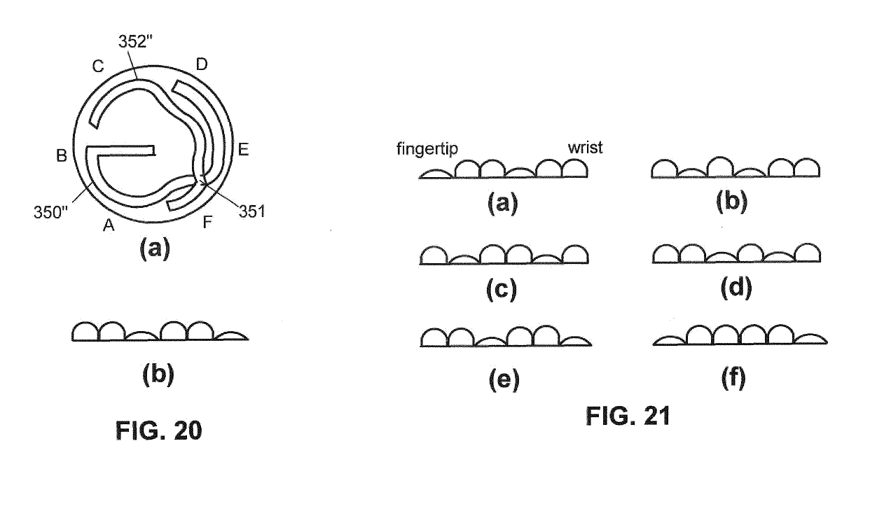

FIG. 20(a) is a further modified rotor configuration and FIG. 20(b) is a simplified side view of a fluid bag showing a principle of yet another mode of operation of an embodiment of the hand massager of FIGS. 9A-9C resulting from the further modified rotor; and

FIGS. 21(a)-(f) are simplified side views of a fluid bag showing a principle of another mode of operation of an embodiment of the hand massager of FIGS. 9A-9C.

### FIRST EMBODIMENT

As shown in FIG. 1, there is provided a hand massager 1 comprising a casing 10 with entrances 14 by which a user can insert his hands into the massager 1. The entrances 14 are angled away from each other so that the user can comfortably insert both hands at the same time. A control panel 12 with operation/control buttons is also provided. The hand massager 1 may be either mains or battery powered.

FIG. 2 is a longitudinal cross-sectional view of the hand massager 1. As shown in FIG. 2, the casing 10 comprises a bottom wall 12, a top wall 16 and side walls 18. In addition, a base board 50 is provided within the casing 10, splitting it into a bottom section 60 and a top section 70. The entrances 14 provide access for the hands 30 into the top section 70.

Four fluid bags 20 (22, 24, 26, 28) are disposed inside the top section, each forming a loop. Accordingly, when the user inserts a hand 30 through the entrance 14 and into the massager 1, the hand passes into each loop and is surrounded by each of the four fluid bags 20.

As shown in FIG. 3A, each fluid bag 20 surrounds a different section of the hands. It will be appreciated that there is some overlap between which parts of the hand are surrounded by which fluid bags. In general, however, fluid bag 22 surrounds the fingertips, fluid bag 24 surrounds a middle portion of the fingers 32, fluid bag 26 surrounds a lower or proximal portion of the fingers, and fluid bag 28 surrounds the meat of the hand 30 and the lower part of the hand 30 towards the wrist. It should be noted here that the expression ‘lower portion’ and ‘proximal portion’ of the fingers is intended to include the upper knuckle joints, closer to the wrist than the web between the fingers.

FIG. 3A also shows a fifth fluid bag 29 provided to cover the thumb. However, this is optional and it is preferred instead that the fluid bags 24, 26 and 28 extend across to cover the thumb.

Returning to FIG. 2, a pump 40 and control electronics 45 are provided in the bottom section 60 beneath the base board 50. The control electronics may comprise a microcontroller, ROM and RAM as desired. For example, when the massager 1 is turned on, the control electronics 45 may be bootstrapped to load an operation routine (program) stored in the ROM into the RAM. The control electronics 45 comprises a microprocessor arranged to accept inputs from the operation panel 12, including pressure setting, heating, release and sequence setting commands, as well as inputs from pressure sensors 46. Each of the inputs may be stored in the RAM until called on by the operation routine. It should be appreciated that any or all components of the control electronics may be implemented in software or hardware and may be disposed within the massager 1 or externally. For example, control of the massager 1 and/or updating of the operation routine can be carried out by an external computer, such as a laptop computer, connected to the massager 1. Also, the section 60, which is a bottom section in FIG. 2, may instead by located by the side of the section 70.

As shown in FIG. 3B, the pump 40 comprises a manifold 41 to which a plurality of tubes 44 is connected, which are in turn connected to respective fluid bags 20. A valve 42 is shown in each tube 44. Thus, the pump 40 is connected to each of the fluid bags 20 by means of a tube 44 with a valve 42. However, the valves 42 may instead be provided in the manifold, and/or a separate pump may be provided for each fluid bag, and/or a separate release valve may be provided directly in one or more fluid bags. It is preferred that the valves 42 are three way valves to allow separate filling, closing and deflating of each bag and that operation of the valves 42 is controlled by the microprocessor 45. Alternatively, the valves may be two-way valves performing the filling and closing functions, with a separate exhaust valve being provided for each of the bags.

The control electronics 45 is programmed to control operation of the pump 40 and the valves 44 (or of the separate pumps) and is therefore able to control inflation of each fluid bag 20 on an individual basis. Preferably, a pressure sensor is provided for each fluid bag and the control electronics 45 is arranged to use the sensed pressure to determine when any individual bag has been filled the appropriate amount. The pressure sensors may be disposed within the tubes or manifolds, or may comprise a pad provided between a fluid bag 20 and one of the base board 50, the top wall 16 and a side wall 18 of the casing 10.

In FIG. 2, each fluid bag is shown as being inflated with air. Thus, the fluid bags exert pressure on the respective parts of the hand.

During operation of the massager, the hands 30 may be effectively trapped by activation of the fluid bags 20. In preferred embodiments, the control panel 12 therefore also comprises an emergency release button, which can be activated for example by depression by the user's nose and chin (or, in the case of a one handed device, the hand not being treated). Alternatively, the emergency release button may be situated at the entrance to the massager 1—for example, underneath the wrist or forearm. Preferably, activation of the release button switches all the valves to open so that air can be discharged from the fluid bags 20. In some embodiments, the massager 1 may also incorporate a vacuum release (not shown), in which the open outlet of the valve is connected to a vacuum or other suction means to rapidly evacuate air from the fluid bags.

In the figure, the height of each fluid bag 20 when inflated is greater than the height between the base board 50 and top wall 16 of the casing 10. Thus, the bottom of each fluid bag 20 presses against the base board 50 and the top presses against the top wall 16 of the casing 10. Since the base board 50 and the casing 10 are fixed in position, the pressure exerted by the fluid bags is greater and is better controlled. Moreover, the fluid bags are forced into intimate contact with the hand and apply pressure to different parts of the hand more uniformly. This maximises the surface-area contact with the skin.

This is illustrated by comparison with FIG. 4, which illustrates a less-preferred embodiment of the present invention. In FIG. 4, the fluid bags 22′, 24′, 26′ and 28′ do not abut the top wall 16′ or the base board 50′ when inflated. Consequently, the area of contact with the hand 30 is reduced and there is a gap 52 between the respective fluid bags. Thus, each fluid bag 20′ has a smaller point of application of pressure to the hand 30, and some parts of the hand 30 are not contacted at all.

In addition, in FIG. 2 the combined width of the fluid bags 20 is greater than the width of the casing (in the longitudinal direction of the fingers). This forces the fluid bags to abut one another when inflated and again the fluid bags are forced into intimate contact with the hand. Moreover, this ensures that any gaps 52 between the fluid bags in the contact region with the fingers are minimised or eliminated.

The ‘height’ and ‘width’ features may be provided separately or in combination. It is preferred that the combined volume of the fluid bags 20 is greater than the internal volume of the top section 70 (which may be termed the ‘volume’ feature) to ensure close contact with, and even application of pressure to, the hands, and particularly the joints.

Although FIG. 2 shows all the fluid bags 20 inflated simultaneously, in the present invention the control electronics are arranged during massaging to inflate or further inflate the fluid bags 20 sequentially whereby increased pressure is applied, for example, first to the fingertips, then the middle of the fingers, then the top of the fingers and then the meat of the hand in sequence.

In practice, the user inserts his hands 30 into the massager 1 when the fluid bags are deflated or only partially inflated. Depending on the programming of the control electronics 45 or the setting selected by the user, the control electronics 45 may begin the massage cycle immediately or may partially inflate all the air bags to a predetermined pressure before beginning the massage cycle. When the massage cycle begins, the control electronics 45 (further) inflates fluid bag 22, while leaving fluid bags 24, 26 and 28 deflated (or partially inflated), by controlling the pump 40 and the manifold (not shown). The controller then inflates fluid bag 24 and releases air from fluid bag 22, by controlling the pump 45, manifold (not shown) and/or valve 42 as appropriate. The precise timing of the inflation of fluid bag 24 with respect to the release of air from fluid bag 22 can be varied, but in a preferred embodiment they occur substantially simultaneously. Subsequently, the controller inflates fluid bag 26 and releases air from fluid bag 24; inflates fluid bag 28 and releases air from fluid bag 26; inflates fluid bag 22 and releases air from fluid bag 28 and so on.

In this way, the massager 1 applies pressure to the fingers of the hand, the application of the pressure to the fingers travelling in a first direction A (see FIGS. 2 and 3A) from the fingertips towards the proximal ends of the fingers, and then on to the meat of the hand and the wrist towards the heart. Specifically, in this embodiment, the massager applies pressure to the fingers in a wave travelling from the fingertips, over the knuckle joints and towards the heart.

It has been found that massaging the hand in this way is particularly beneficial for sufferers of rheumatoid arthritis,. In particular, the effect of the massage by the massager 1 of the present invention is to massage the joints of a rheumatoid arthritis sufferer, which may be inflamed and swollen after a period of prolonged inactivity such as sleeping. Because the massage is applied as a wave of pressure travelling in direction A from the fingertips towards the heart, the fluid in the joints can be gently massaged out of the hand, and the swelling and inflammation relieved. Thus, the user regains motion of the fingers and stiffness is reduced.

Moreover, because the fluid bags are constrained by their relative size within the casing 10 and by the base board 50, they evenly apply pressure to the fingers over a wide contact area. Thus, they significantly improve the quality of the massage both to the joints and to the portions of the fingers between the joints, without painful contact points of increased pressure.

It will be appreciated by those skilled in the art that the massager 1 of the present invention has general application, and will be beneficial to any person seeking a massage, and not only those suffering any illness or disease.

### VARIATIONS

In the hand massager 1 so far described, four fluid bags are provided in the longitudinal direction of the fingers. However, more or fewer bags may be provided so long as it is possible to apply pressure moving along the fingers in direction A, and in particular to apply a wave of pressure to the fingers. Preferably, therefore, at least three fluid bags are provided to cover and massage the fingers.

In addition, in the embodiment a single fluid bag 20 is provided for each region of the fingers, each fluid bag 20 covering both the top and bottom of all fingers of the hand 30. However, it is possible to provide for each region a fluid bag covering the top of all fingers and another fluid bag covering the bottom of all the fingers. This allows the sequence of filling of the top and bottom bags for a particular region of the fingers to be varied to improve flexing of the joints. For example, if one or more of the fluid bags 20 were to be split into an upper bag and a lower bag, the lower bag could be filled slightly before the upper bag and the pressure in the lower bag could be released slightly before that in the upper bag. Moreover, filling of the adjacent lower bag could begin before pressure is released from the upper bag. This would serve to increase flexing of the lower finger joints. It will be appreciated that other filling sequences could be used. Similarly, different fluid bags 20 could be provided for different fingers, allowing for separate massage of the fingers and for the joints of different fingers to be flexed individually.

The fluid bags 20 are made of PVC or an equivalent material. PVC has the advantage of being a strong, impermeable material allowing fluid bags 20 to be made with little or no risk of leaks. Moreover, PVC fluid bags 20 can be made with a degree of elasticity and/or sufficient weight that the fluid bag collapses to a desired extent when the valve 44 is opened to release air, thereby allowing the pressure applied to the hand to be released at a desired speed, and promoting the wave effect. Those skilled in the art will recognise that other materials are suitable, e.g. thermoplastic polyurethane (TPU).

Although not essential, in preferred embodiments, the hand massager 1 of the present invention further comprises a heater 51 (see FIG. 3B). The heater may heat the air (or other fluid) disposed in the bags 20, either before it is pumped into the fluid bags 20 or by means of a filament within the fluid bags 20. The heater may also or instead comprise an electric heating pad disposed within the top portion 70 of the casing 14 and/or may be an infrared (e.g. carbon fibre) heater. Providing a heater improves the massage given and assists in easing the stiffness in joints.

In preferred embodiments, the hand massager 1 is further provided with an internal UV light 53 (see FIG. 3B). The UV light 53 can be switched on, in order to kill bacteria and viruses.

As described above, the massager 1 is provided with a control panel 12 with various operation keys. In preferred embodiments, the control panel allows the user to select the pressure applied generally or for individual regions, the temperature, the speed of the wave of pressure, and the sequence in which pressure is applied to the different regions. For example, if there were ten bags numbered 1-10 in direction A, it would be possible to inflate the bags in the order 1, 3, 5, 7, 9, 2, 4, 6, 8, 10 . . . ; or the order 1, 2, 3, 4, 5, 6, 7, 8, 9, 10 . . . ; or the order 1, 2, 3, 4, 2, 3, 4, 5, 3, 4, 5, 6, 4, 5, 6, 7 . . . ; and so on, in each case, the point of application of pressure moves, in this embodiment, in direction A.

It should also be appreciated that it is not necessary to release pressure from one bag while the adjacent bag is filled. For example, all the bags could be filled sequentially so that at the end of the sequence all bags are filled, and then pressure is released from all bags simultaneously (or in any desired sequence). In the same way groups of bags could be inflated in sequence, for example it would be possible to inflate bag 1, then bag 2, then bag 3 while releasing bag 1, then bag 4 while releasing bag 2, and so on so that there are generally two bags inflated at the same time.

In the description so far, the fluid bags 20 are filled exclusively with air by means of the pump 40. However, they may be filled with any other appropriate fluid, including any appropriate gas or liquid (in this specification, unless distinguished the expression ‘liquid’ includes gels, sols, emulsions, foams and other colloids). In all embodiments, where a liquid is used, it is particularly preferred that the liquid is a heat retaining liquid, and in particular a heat retaining gel is preferred. Thus, for example, a gel commonly known as CMC (sodium carboxymethyl cellulose) can be employed. This can retain both heat and cold and is soluble in water.

In the description so far, the massager 1 is adapted to massage two hands and has two entrances 14. However, it may have a single entrance 14 for both hands. Similarly, it may have a single entrance for one hand—that is, the massager 1 need not be capable of massaging two hands at a time.

In the present invention, although generally preferred, it is not necessary to provide means for applying pressure to both the front and back of the fingers 32 (or to other parts of the hands 30). Rather, it is sufficient to apply pressure to only the top or bottom of the fingers. As such, the fluid bags 20 can be provided such that they cover only the top and/or the bottom of the fingers.

Any one or more of the above-described variations, including the ‘height’, ‘width’ and ‘volume’ variations, may be incorporated in the further embodiments described below.

### SECOND EMBODIMENT

In the foregoing embodiment, pressure in the fluid bags 20 is increased to provide a massaging effect by pumping more fluid into the fluid bags 20. However, the pump 40 may be noisy or expensive, or both, and may require regular maintenance. This is particularly the case with air pumps, which are generally noisy and have moving parts prone to being clogged by dust. A further disadvantage of air and other gas pumps 40 is that it is difficult to accurately control and vary the pressure within the fluid bags 20. In alternative embodiments, pressure is therefore applied to the hands by disposing a predetermined volume of fluid within the fluid bags and displacing the fluid within the bags.

In a second embodiment of the invention, as shown in FIGS. 5A and 5B, the massager 1A has a plurality of fluid bags 20A, at least one for each region of the fingers 32, as in the first embodiment. In this case, an upper fluid bag 24A and a lower fluid bag 24B is provided for each region of the fingers of both hands. However, it would equally be possible to provide a fluid bag that covers the top and bottom of a region of the fingers of one hand; or an upper fluid bag and a lower fluid bag for a region of the fingers of each hand, and so on.

All the fluid bags 20A for all regions are sealed and partially filled with a predetermined volume of liquid, preferably a gel 78, although gases and other fluids may also be used. It should be noted that the bags 20A need not be permanently sealed, so long as the gel 78 can be displaced within the bag 20 to exert pressure on the hands. For example, the bag 20A may be empty when the hands 30 are placed in the massager 1A, the predetermined volume of fluid can then be filled into the bag 20A, and the bag 20A can then be sealed prior to displacement of the fluid within the bag.

FIGS. 5A and 5B show transverse sectional views through the hand 30 (including fingers 32) in which a predetermined volume of gel 78 is provided in each of a sealed upper bag 24A and a sealed lower bag 24B, which together surround the middle portion of the fingers 32 of the hand 30. As shown in the figure, plates 80 are attached to the upper middle portion of the upper bag 24A (plate 80A) and to the bottom middle portion of the lower bag 24B (plate 80B) respectively. The plates 80 include holes at either end, which run along columns 82 provided between the top wall 16 of the casing 10 and the base board 50. (The bottom wall 12 of the casing 10 and the control electronics 45 are not shown for simplicity). A solenoid 84 is mounted to each plate 80 and controlled by the control electronics 45.

The columns 82 also penetrate sealed holes in each of the upper and lower bags 24A, 24B. Although not obvious from the drawing, the bottom of the upper bag 24A and the top of the lower bag 24B are fixed to the columns at predetermined heights.

In FIG. 5A, the control electronics 45 controls the solenoids 84 to separate the plates 80, thereby drawing the top of the upper bag 24A upwards and the bottom of the lower bag 24B downwards. Because the bottom of the upper bag 24A and the top of the lower bag 24B are fixed to the columns at predetermined heights, at the middle part of each bag a space 86 is created between the top and bottom into which the gel can move. Accordingly, pressure is not applied to the hands 30.

In FIG. 5B, the control electronics 45 controls the solenoids 84 to move the plates 80 along the columns 82 towards each other. This closes the space 86 at the middle of each bag, thereby forcing the gel 78 out of the space. As the gel 78 is displaced, it moves into the parts of the bags 24A, 24B between the hands 30 and the top wall 16/base board 50. As movement of the gel is constrained by the top wall 16, side walls 18, base board 50 and plates 80, it is forced to exert pressure on the hands. This is schematically represented by the arrows shown on the left hand side of bags 24A, 24B of FIG. 5B.

Accordingly, by providing at least one bag 20A for each of the different regions of the fingers and a corresponding plurality of solenoids 84, it is possible to exert a pressure on the fingers of the hands, the application of the pressure on the fingers travelling in a first direction from the fingertips towards the proximal ends of the fingers. Thus, it is again possible to provide a wave of pressure suitable for massaging an arthritic hand.

It should be noted that in the present embodiment, as in the first embodiment, pressure can first be applied to all regions of the fingers 32 and other parts of the hand 30, before additional pressure is applied to the respective regions in sequence via the fluid bags.

The massager 1A of the present embodiment has the same advantages as those described above and can also be modified as described above. In addition, the massager 1A has the further advantages that operation of the solenoids is much quieter than that of the pump arrangement. Moreover, the solenoids are less prone to damage from dust and ambient conditions. There is also reduced scope for leakage at the manifold 41, tubes 42 and valves 44 in cases where these are not provided and the bags 20A are permanently sealed. Accordingly, the user experience is improved and less maintenance is required.

Moreover, displacement of the solenoids 84A, 84B and plates 80A, 80B can be accurately and individually controlled, thereby allowing precise control of the amount of pressure applied to the tops and bottoms of the fingers 32. However, it remains preferable to provide pressure sensors to measure pressure rather than relying on the displacement distance of the plates 80 in order to calculate the amount of pressure. This makes it possible to consistently apply the desired pressure irrespective of the size of different users' hands, thereby further improving the user experience. It will be appreciated that the amount of pressure applied to the hands 30 may also be controlled by increasing the predetermined volume of fluid in the bags 20A.

It is not essential to provide upper and lower bags 24A, 24B for each region—rather a single bag 20A can be provided for each region, as in the first embodiment, or more bags can be provided, for example one or two for each finger. Moreover, it is not essential to tether the bag(s) at a predetermined height (or at all) to the columns 82. It is also not essential to provide two solenoids 84 and/or plates 80 for each region—a single plate 80 and solenoid 84 can apply pressure for the whole finger in any region, irrespective of whether there is one bag 20A or more.

As in the first embodiment, it is possible to more precisely control flexing of the joints during the massage by providing an increasing number of bags/solenoids in the longitudinal direction of the fingers and by applying pressure first to the bottom of a portion of the finger and then the top, or vice versa.

Although the means for displacement are shown as solenoids, it will be apparent to those skilled in the art that other displacement means could be used. These include, by way of non-limiting example, hydraulic means and stepping motors, such as ultrasonic motors, whose position can be precisely controlled and which can be quietly operated. It can also be conceived that instead of providing a plate, moving portions of the top wall 16 or base board 50 can be used. Also, by “solenoid” is meant not only a plunger-type solenoid (using so-called “bang-bang”-type control), but also a motorized solenoid.

In addition, it is not necessary to use plates 80 as the displacement means—other forms of displacement means can also be envisaged, including rollers. The displacement means need not be provided at the centre of the bags 20A but can be provided at the sides as well or instead. In any event, any shape can be used, so long as the fluid 78 can be displaced within the bag 20.

The skilled person will appreciate that the second embodiment may be combined with the first embodiment and with the aforementioned variations on the first embodiment.

### THIRD EMBODIMENT

The present invention also envisages the use of a glove, which could act as a barrier between the hand and the fluid bags, resulting in a more hygienic form of massager. FIGS. 6A and 6B show such a glove 90, but which performs an additional function. This additional function is achieved by the provision of firm pads 92, which may be sewn into the glove or moulded into the fabric of the glove (e.g. by a twin-shot injection moulding method), for example. The pads may be composed of, e.g., rubber or plastic and may be provided on the outside of the glove as a pad 92A and/or on its inside as a pad 92B—see FIG. 6B. The pads are placed so as to apply pressure at specific points on the hand.

In the illustrated example they are placed over the tendons of the hand, but alternative locations are at acupressure and/or reflex pressure points.

As shown in FIG. 6B, this glove works in conjunction with fluid bags 22, 24, 26 and 28, which are inflated (e.g. with air) so as to create a pressure wave along the hand in the direction A. One of these, namely bag 26, is shown more inflated with fluid than the other bags and consequently exerting pressure onto the pads 92 directly underneath the bag. Because the pads lie over the tendons, this applied pressure will directly affect the tendons (or various pressure points, as already mentioned). Even if only the upper pads 92A are provided, this will still apply pressure through the material of the glove. However, slightly enhanced pressure may be applied where the lower pad 92B is provided.

The skilled person will appreciate that the third embodiment may be combined with any of the preceding embodiments.

### FOURTH EMBODIMENT

FIGS. 7A and 7B are a front view and a side view, respectively, of a hand massager according to a fourth embodiment of the present invention.

The hand massager comprises a massage unit 100 and a base unit 102. The massage unit is of a clamshell-type design having front and rear sides 104, 106, which are joined by a hinge section 108. Attached to the inside surfaces of the front and rear sides are a front and rear foam member, respectively, 110 and 112. The foam member is shown as having a textured (undulatory) form, but may alternatively be untextured. The base unit 102 houses a pump (not shown) and pump-control electronics and has a U-shaped portion 114 for receiving the hinge end of the massage unit 100.

FIGS. 8A-8C show perspective views of the massage unit with provision for the insertion of a user's hand. In the embodiment shown the massage unit comprises an outer skin 111, which may comprise a rubberized fabric, and the foam members 110 and 112 are constituted by a first foam layer 113 formed on the outer skin and a second foam layer 115 formed on the first foam layer. The second foam layer 115 lies next to the user's skin and is washable. (Alternatively, only one foam layer may be used.) In FIG. 8A the second foam layer of one of the foam members 110 or 112 has recesses 116 for the fingers and thumb of the user. This would be suitable for the user's left hand. For the user's right hand the same pattern of recesses may be provided on the other foam member, but with the thumb recess on the opposite side. In FIG. 8B the user's left hand rests on the foam member, but instead of the fingers themselves lying in the recesses 116, a series of finger attachments 118, which are fitted onto the end of the fingers and thumb, lie in the recesses. Attached to the distal ends of the finger attachments 118 are respective flexible tubes 120, which are attached to a manifold (not shown) accommodated within the first foam member of the massage unit. The manifold is fed by a single tube 122 leading from the massage unit to the base unit.

FIG. 8C shows the user's right hand resting on the foam member. In this mode of use the user is making use of the same recesses in the foam member that would normally be used with the left hand (see FIG. 8A), but this time with the thumb not engaged with the thumb recess. Again, the fingers—and possibly the thumb also—will have fitted to them the finger attachments 118.

In practice, the user will set controls (not shown) provided on the base unit, in order to set a rate of flow of fluid pumped by the pump through the tubes 120 and through the finger attachments 118. The preferred fluid in this case is air, which is forced past the gap between the finger attachments and the fingers (and, where appropriate, the thumb) and out through the proximal end of the finger attachments. Either the clamshell can be left open during operation, or it can be closed. The latter provides a snug fit of the hand inside the massage unit, while still allowing the pumped air to exit the massage unit. Closure of the clamshell can be effected by, e.g., a hook-and-loop fastener—see the flexible fastener tab 130 in FIGS. 7A and 7B, which is attached at one end to the side 106 of the massage unit and engages with the fixed fastener tab 132 provided on the other side 104 of the massage unit.

If desired, the massage unit in its closed state with the user's hand inside can be mounted on the base unit instead of lying apart from the base unit on a suitable surface or on the user's lap. In that case, of course, the hand will be lying vertically. However, this should pose no difficulty for the average user.

In a variant of the illustrated embodiment, both hands may be massaged simultaneously by increasing the height of the massage unit 100, as seen in FIG. 7B, and providing two sets of recesses 116 side by side. These side-by-side sets of recesses may allow the user to lay both hands side-by-side in the same direction, or in opposite directions. In the latter case one arm protrudes from one side of the massage unit, while the other arm protrudes from the other side. Alternatively, the depth of the massage unit (into the page shown in FIG. 7B) may be increased and the two sets of recesses provided side by side in that depth direction. In this case the user's hands will necessarily lie in the massage unit in opposite directions.

In a yet further variant of this embodiment, the tubes 120 are taken back individually to the base unit 102, and the pump-control electronics in the base unit may be arranged to control the air-flow rate through the individual finger attachments separately.

### FIFTH EMBODIMENT

A hand massager 200 of a fifth embodiment of the invention is illustrated as an overall perspective view in FIG. 9A. The hand massager is in two parts: a base unit 202 and a hand unit 204. These are shown individually, again in perspective view, in FIGS. 9B and 9C, respectively. In FIG. 9B the base unit 202 can be seen to have a recessed portion 206 for receiving a rounded base portion 208 of the hand unit 204 and a conduit portion 210, which carries fluid pumped by a pump located in the base unit to a distributor, contained within the hand unit 204. The base unit 202 also includes a control switch 212 and a display 214, whereby the operation of the hand massager can be controlled by the user.

The hand unit 204 in its opened state is shown in FIG. 10. The hand unit itself is in two parts: an upper part 216 and a lower part 218. These two parts are connected to each other by means of a hinged section 220 and each contain a fluid bag 222. The part 218 contains the distributor 300. The two parts 216, 218 are relatively rigid, in order to act as a reaction against the inflation of the fluid bag. The fluid bag 222 is shown in perspective view in FIG. 11 and in orthogonal views in FIGS. 12(a)-12(f) and comprises a plurality of adjacently disposed inflatable sections 214, 216, 218, 220, 222 and 224, which are isolated from each other by separating sections 225. A number of tabs 226 are provided, which serve to attach the bag to the upper or lower parts 216, 218 of the hand unit. To this end the tabs may be one half of a hook-and-loop arrangement, the other half being corresponding pads fixed to the parts 216, 218.

The bag 222 comprises a first skin 228 and a second skin 230. These two skins are each vacuum-formed into a three-dimensional shape such that, when they are joined together and the bag is in its non-inflated state, a cavity is formed at the locations of the inflatable sections 214-224, the two skins being in contact with each other at the locations of the separating sections 225 and at a flange portion 231 extending around the periphery of the bags. Such contact may be formed by welding or stitching, depending on the material of the skins. TPU is an ideal material, since it lends itself readily to vacuum-forming and RF welding and is also more flexible than PVC. However, PVC could be used as well. A series of nozzles 232 are attached (e.g. welded) to the second skin 230 and communicate with the cavities in the respective inflatable sections 214-224. A fluid, nominally air, is introduced into the nozzles from a source of such fluid (see below), in order to inflate the inflatable sections 214-224.

In use, the user places his or her hand 30 between the two bags 222 in a manner shown in FIG. 13, such that the wrist 234 lies against one end of the bags, while at the other end the fingers protrude beyond a shoulder portion 236 and lie against an extension portion 238 of the bags. This is shown in the context of the hand unit in FIG. 14. Once the hand is in place, the user uses his other hand to close the hand unit and start the massaging process. Closure of the hand unit may be achieved by means of a hook-and-loop fastening arrangement between the parts 216, 218 or by means of a latching mechanism which can be released by a button such as the button 219 shown in FIG. 10. The other hand can be treated in the same way as the illustrated hand if the other hand is inserted palm upwards.

As already mentioned, the hand unit includes a distributor for supplying fluid (again, nominally air) to the nozzles 232. An embodiment of the distributor is illustrated in exploded form in FIG. 15 and comprises a motor 302, which drives a rotor 304 inside a base member 306. The base member 306 is connected to the motor 302 as follows: firstly a plate 318 is secured to the motor via a pair of bolts 310 which pass through a pair of holes 312 provided in the plate 318 and engage in corresponding female threads at the end of the motor from which the motor shaft 314 protrudes; secondly, a cap member 316 is secured to the plate 318 by means of bolts (not shown), which pass through the holes 319 and into corresponding female threads 320 formed in the cap member 316; thirdly, the rotor 304 is brought into engagement with the shaft 314 after passing a spring 322 over a collar portion 324 of the rotor and placing a second plate 326 over the upper end of the spring; finally, the base member 306 is attached to the cap member 316 by means of bolts 328 which pass through holes 330 formed in the cap member and engage with corresponding female threads 332 formed in the base member 306. The spring 322 has at each end a catch 322′. When the shaft rotates, one of three tabs 304′ on the collar portion 324 of the rotor engages with one of the catches 322′, while the other catch 322′ engages with one of three tabs (not shown) provided on the underside of the plate 326. Consequently, rotation of the rotor causes rotation of the plate 326. On the upper surface of the plate 326 are three small protrusions 326′. During operation of the distributor these rotate against the underside of the cap member in an upper region 317. Use of such protrusions creates less friction than if the whole plate 326 were rotating against the cap member. Moreover, less friction still is created if the plate and/or the cap member is made of a low-friction material, e.g. polypropylene. While in the drawing three protrusions 326′ are shown, in practice more or less than three may be used. Three is the preferred number, however, since it is the minimum number providing stable seating of the plate against the cap member. Moreover, more or less than three tabs 304′ (e.g. as few as one) may be employed on both the rotor 304 and the plate 326.

The base member 306 is shown in various views in FIGS. 16(a)-16(e). More specifically, FIGS. 16(a)-16(c) are top, side and bottom views, respectively, while FIGS. 16(d) and 16(e) are top-side perspective and bottom-side perspective views, respectively, of the base member. The base member comprises an infeed nozzle 340 and a plurality of outfeed nozzles 342. Turning to the rotor, this is shown in top, side and bottom views, respectively, in FIGS. 17(a)-17(c), while FIG. 17(d) is a bottom-side perspective view. The rotor comprises two generally arcuate channels: 350 and 352. Channel 350 extends circumferentially over a little over 180° (see FIG. 17(c))—in the example shown, around 190°—and extends through most of the thickness of the rotor body 354, being closed off at the upper end 356 of the rotor body by the top wall 358. One end of the channel 350 extends to the centre of the rotor via a straight section 353. The channel 352, on the other hand, extends circumferentially only over about 105°, but is likewise terminated by the top wall 358 of the rotor body, except for an area of the top wall in which a short vent segment 360 provided. This segment is preferably radially shorter than either of the channels 350, 352 and allows fluid that enters the channel 352 to be exhausted to atmosphere.

When the distributor is fully assembled, the spring 322 urges the lower end 362 of the rotor 304 (see FIG. 17(d)) against the upper inside surface 344 of the base member 306 (see FIG. 16(d)). Since friction will be created between these two parts (rotor and base member), it is desirable that one or both of these parts be made of a material having a low coefficient of friction, like the plate 326. Again, polypropylene is a suitable material. This means that the only fluid entering the outfeed nozzles 342 is the fluid being supplied through the infeed nozzle 340 and the channel 350. As the rotor rotates, the fluid from the nozzle 340 will enter several of the nozzles 342 simultaneously, while the remaining nozzles 342 communicate with atmosphere via the channel 352 and the vent segment 360. The air leaving the vent segment 360 is able to pass between the collar 324 and the central hole of the cap member 316 to atmosphere. In the embodiment as illustrated, at any one time four of the six nozzles 342 will communicate with the nozzle 340, while the remaining two will vent to atmosphere. This is because the channel 350 extends circumferentially over >180°, and therefore must communicate with four of the nozzles 342. Looking at FIG. 16(c), and identifying the outfeed nozzle openings as A-F, nozzle openings A-D, say, will initially communicate with the infeed nozzle 340, while nozzle openings E and F vent to atmosphere. Then, when the rotor has rotated in the direction of the arrow 364 by 60°, nozzle opening A starts to vent (F is still venting) and nozzle opening E communicates with nozzle 340, and so on in turn. The effect that this has on the fluid bag 222 depends on how the nozzles 342 are connected to the fluid-bag nozzles 232 (see FIG. 12).

Assuming that the nozzles 342 are connected as shown in FIG. 12(a))—i.e. nozzle openings A-F in FIG. 16 connected respectively to nozzles a-f in FIG. 12—and assuming that, initially, nozzle openings c-f are being fed from the infeed nozzle 340, while the nozzle openings a and b are venting to atmosphere, then the result will be that, initially, the end two inflatable sections 214 and 216 of the fluid bag will be deflated (marked as “D” in FIG. 12(a)), while the bottom four inflatable sections 218, 220, 222 and 224 will be inflated (marked as “I) in FIG. 12(a)). Then, as the rotor rotates, section 218 will deflate and section 214 will inflate (sections 220, 222 and 224 being still inflated), then section 216 will inflate, while section 220 deflates (sections 222, 224 and 214 being still inflated), and so on. This is illustrated as a simplified side view of the fluid bag in FIG. 18.

FIGS. 18(a) and 18(b) show the situation as just described in the preceding paragraph—that is, in FIG. 18(a) the two inflatable sections nearest to the fingertips are deflated and the rest inflated, then in FIG. 18(b) the leftmost inflatable section is inflated, the next two are deflated and the rest inflated. As the rotor rotates, the venting action affects successive inflatable sections, giving the result shown in FIGS. 18(c)-18(f). This is yet another example of a pressure wave travelling—as with the first embodiment—from the fingertips to the wrist, though the reverse action is equally possible.

A somewhat different mode of operation is illustrated in FIGS. 19(a)-19(g). In FIG. 19(a) the rotor is modified so that each of the arcuate channels 350′ and 352′ communicate at any given time with three of the six outfeed nozzle openings in the base member. This gives the behaviour shown in FIGS. 19(b)-(g). Again, there is a pressure wave from left to right, but this time the area being massaged at any given time by the inflated sections of the fluid bag is smaller than that massaged in the mode of operation illustrated in FIGS. 18(a)-18(f). A different mode of operation again is to have the vent channel 352 communicate with only one outfeed nozzle at a time, while the channel 350 communicates with five. This has the opposite effect in that the area of the hand being massaged at any given time by inflated sections of the fluid bag is larger than in the mode of operation shown in FIGS. 18(a)-18(f).

A still further mode of operation is shown in FIGS. 20(a) and 20(b). In FIG. 20(a), the rotor has been modified so that the infeed nozzle supplies, in this position of the rotor, outfeed nozzles A, B, D and E via the channel 350′, while nozzles C and F vent to atmosphere via the channel 352″. The effect of this on the fluid bags is shown in FIG. 20(b). Here the sections being vented are not adjacent to each other, but are separated from each other, so that at any given time there are two separate parts of the hand that experience pressure from the inflated sections. The pattern shown in FIG. 20(b) ripples down the bag as the rotor rotates.

Channels 350″ and 352″ by necessity cross over each other at point 351. To achieve this, a short separating wall is provided between the two channels. Put another way, channel 350″ tunnels under channel 352″, or vice-versa.

Yet another mode of operation is shown in FIGS. 21(a)-21(f). Here the rotor is as in FIG. 17. However, in this case, instead of the nozzles A-F (see FIG. 16(c)) being connected respectively to nozzles a-f on the bag (see FIG. 12(c)), they are connected respectively to nozzles c, f, a, d, b and e on the bag. By changing the connections in other ways, other different pressure-wave patterns may be created.

Although specific angular extents of the channels 350 and 352 have been specified, in practice these extents need only be such as to cover the appropriate number of outfeed nozzle openings simultaneously.

Returning to the fluid bags 222, FIG. 10 shows two of these attached to the upper and lower parts 216, 218, respectively, of the hand unit. Since they will both be in contact with the hand, once the upper and lower parts are closed together, it is envisaged that they will both be operated in tandem by the pump and distributor. Thus, the nozzles of both bags will be supplied in parallel with fluid (nominally air) from the distributor via respective tubes, so that the inflatable sections of both bags are inflated and deflated according to the same pattern. In other words section 214 of one bag will be inflated/deflated together with section 214 of the other bag, and so on for the other sections 216-224. However, if desired only one of the two bags may be operated at any given time. Also, as with the first embodiment, the pressure-wave timing of one bag may be different from that of the other bag. This may be achieved by connecting the tubes for one bag to the distributor differently than for the other bag, so that, for example, the pressure-wave pattern for one bag is one or more inflatable sections delayed relative to the pressure-wave pattern for the other bag.

In the fifth embodiment, the fact that the bags are a well-defined shape, produced by, e.g., vacuum-forming, allows the inside of the clamshell to be correspondingly shaped—that is, a well may be formed in the inside of the clamshell for receiving the bags. This means that it is easier to locate the bags in the clamshell, also the bags will tend not to migrate out of the well. Furthermore, when the bags are shaped as shown in FIGS. 11(a)-11(f)—that is, with individual three-dimensionally formed sections 214-224 demarcated by narrow separating sections 225 (see FIG. 11), which extend down to the opposite skin 230 and are welded or stitched to that opposite skin—then, when the bag sections are inflated, the separating sections tend to close up where the skin 228 meets the hand. This enables the pressure wave to affect the whole hand. This 3-D shaping of the bags also distinguishes the present invention from the known bags, which tend to be two-dimensionally shaped, i.e. flat when deflated, and inflate into a cylindrical or “pillow” shape.

While the various embodiments have been described as involving a pressure wave in a direction from the fingertips toward the heart, this being particularly helpful in cases of rheumatoid arthritis, the present invention is not limited to this. Thus the pressure wave may be in the reverse direction.

Although the channels 350, 352, 350′, 352′, 350″ and 352″in the rotor of the fifth embodiment have been shown and described as being arcuate, in practice they may be any desired shape (e.g. be linear or piecewise linear), provided they serve to provide a pathway between the appropriate nozzle openings.

As with the other embodiments, the fifth embodiment may be employed in conjunction with a heater 51 and/or pressure sensors 46 (see FIG. 3B). Furthermore, the number of fluid-bag sections may be less than or more than the six illustrated—e.g. any number between, say, two and eight. The number of outfeed nozzles 342 in the base member of the distributor will vary accordingly.

The foregoing description has been given by way of example only and it will be appreciated by a person skilled in the art that modifications can be made without departing from the scope of the present invention.

1. A distributor for distributing a fluid and comprising:
a motor;
a base member, and
a rotor in driven relationship with the motor and rotatably engaging with the base member;
the base member comprising an infeed nozzle and a plurality of outfeed nozzles, and
the rotor comprising a feed channel and a vent channel, the feed channel being such as to provide a fluid pathway between the infeed nozzle and one or more first nozzles of the outfeed nozzles and the vent channel being such as to provide a fluid pathway between one or more second nozzles of the outfeed nozzles and atmosphere.

2. A distributor according to claim 1, comprising a resilient means for urging the rotor against the base member.

3. A distributor according to claim 2, comprising a cap member disposed between the motor and the base member, the cap member accommodating at least part of the rotor and the resilient means.

4. A distributor according to claim 3, wherein the resilient means is a compression spring, the distributor comprising a rotator plate disposed between the compression spring and the cap member, the distributor being such that the rotator plate can rotate with the rotor and the compression spring.

5. A distributor according to claim 4, wherein the rotator plate comprises one or more protrusions in contact with an inside surface of the cap member.

6. A fluid bag comprising:
a first and second skin, the first skin defining a plurality of fluid-bag sections separated from each other by separating sections, the first and second skins being joined to each other at said separating sections and around a periphery of the first and second skins, each of said fluid-bag sections forming a cavity in a non-inflated state of the fluid bag; and
a plurality of nozzles in fluid communication with respective fluid-bag sections.

7. A fluid bag according to claim 6, wherein:
the first and second skins have been formed by a vacuum-forming process and joined by a welding process.

8. A fluid bag according to claim 6 or claim 7, wherein:
the skins comprise thermoplastic polyurethane.

9. A hand massager comprising pressure means for applying pressure to the fingers of a hand, the application of the pressure to the fingers travelling in a first direction from the fingertips towards the proximal ends of the fingers, or in the reverse direction.

10. A hand massager according to claim 9, comprising a fluid bag having a plurality of fluid-bag sections arranged adjacent to each other in the first direction, each for applying pressure sequentially to the fingers.

11. A hand massager according to claim 10, comprising means for sequentially filling the plurality of fluid-bag sections with a fluid, whereby the fluid bag-sections sequentially apply pressure to the fingers.

12. A hand massager according claim 10, wherein, at the time of application of pressure, each of the fluid bags is partially filled with a predetermined volume of fluid, the massager further comprising displacement means adapted to displace the fluid within the respective bags sequentially, whereby the fluid bags in which fluid is displaced sequentially apply pressure to the fingers.

13. A hand massager according to claim 12, wherein the displacement means comprises at least one solenoid.

14. A hand massager according to any one of the preceding claims, further comprising a casing, wherein the fluid-bag sections are constrained by the casing when applying pressure to the fingers.

15. A hand massager according to claim 11, comprising a massage unit which is of a clamshell configuration having two portions joined by a hinge portion, and a fastening means for closing the clamshell, the massage unit including one or more of said fluid bags.

16. A hand massager according to claim 15, comprising a base unit which includes a pump for pumping fluid to the sections of the one or more fluid bags.

17. A hand massager according to claim 16, wherein the massage unit comprises a means for distributing said fluid to the fluid-bag sections.

18. A hand massager according to any one of the preceding claims, further comprising a pressure sensor for sensing the pressure applied to the fingers.

19. A hand massager according to any one claims 9 to 18, further comprising heating means.

20. A hand massager according to claim 19, wherein the heating means is an infra-red carbon fibre heater.

21. A hand massager according to any one of claims 9 to 20, comprising a pressure release control.

22. A hand massager according to claim 21, wherein the pressure release control is adapted to operate a suction device.

23. A hand massager according to claim 17, wherein said distributing means comprises the distributor according to any one of claims 1 to 5, the outfeed nozzles of the distributor being connected to the fluid-bag sections.

24. A hand massager according to claim 17 or claim 23, wherein the fluid bag comprises a fluid bag according to any one of claims 6 to 8, the outfeed nozzles of the distributor being connected to the nozzles of the fluid-bag sections.
